(19) United States
(12) Patent Application Publication
(10) Pub. No.: US 2023/0155632 A1
(43) Pub. Date: May 18, 2023

(54) Failsafe Series-Connected Radio System

(71) Applicant: Telefonaktiebolaget LM Ericsson (publ), Stockholm (SE)

(72) Inventors: Magnus Nilsson, Lund (SE); Peter Jakobsson, Lund (SE); Jan Celander, Malmö (SE); Martin Isberg, Lund (SE); Torsten Carlsson, Lund (SE); Magnus Sandgren, Staffanstorp (SE); Jan Hederen, Linghem (SE)

(21) Appl. No.: 17/920,595

(22) PCT Filed: Apr. 24, 2020
(86) PCT No.: PCT/EP2020/061521

§ 371 Date: Oct. 21, 2022

(51) Int. Cl. H04B 7/024

(52) U.S. Cl. CPC H04B 7/024

(57) ABSTRACT

A wireless system comprises at least one controlling node and two or more antenna processing nodes coupled to the controlling node but separated from each other. A first antenna processing node communicates (910) with a first controlling node in a first direction along a series of links serially connecting the first controlling node and two or more antenna processing nodes including the first antenna processing node, and relays (920) communications between the first controlling node and at least a second antenna processing node, in a second direction along the series of links. In response to determining (930) that communications with the first controlling node in the first direction have failed, the first antenna processing node communicates (940) with a controlling node in the second direction along the series of links.

### ABSTRACT

The present disclosure generally relates to wireless systems in which a central processing unit for a base station is coupled to a series of spatially separated transmitting and receiving antenna points via serial interfaces. The present disclosure relates more particularly to providing redundancy and resistance to failures in such systems.

### BACKGROUND

The term “cell-free massive MIMO” has been used to refer to a massive Multiple-Input Multiple-Output (MIMO) system where some or all of the transmitting and receiving antennas for a base station are geographically distributed, apart from the base station. Each of the transmitting and receiving points may be referred to as an “antenna point,” “antenna processing node,” or “antenna processing unit.” These terms may be understood to be interchangeable for the purposes of the present disclosure, with the abbreviation “APU” being used herein. These APUs are communicatively coupled to and controlled by a controlling node, which is spatially separate from some or all of the APUs, may be referred to interchangeably as a “central processing node” or “central processing unit”—the abbreviation “CPU” is used herein.

FIG. 1 provides a conceptual view of a cell-free massive MIMO deployment, comprising a CPU 20 connected to several APUs 22, via serial links 10. As seen in the figure, each of several user equipments (UEs) 115 may be surrounded by one or several serving APUs 22, all of which may be attached to the same CPU 20, which is responsible for processing the data received from and transmitted by each APU. Each UE 115 may thus move around within this system without experiencing cell boundaries.

Systems described herein include at least CPU and two or more APUs spatially separated from each other and from the CPU. These systems, which may be considered examples of cell-free massive MIMO deployments, will be called distributed wireless systems herein. FIGS. 2 and 3 provide other views of example deployments of distributed wireless systems. In this scenario shown in FIG. 2, multiple APUs 22 are deployed around the perimeter of a room, which might be a manufacturing floor or a conference room, for example. Each APU 22 is connected to the CPU 20 via a “strip,” or “stripe.” These might also be referred to as “chains” or “branches.” More particularly, the CPU 20 in this example deployment is connected to two such stripes, each stripe comprising a serial concatenation of several (10, in the illustrated example) APUs 22. FIG. 3 shows an two-dimensional model of a factory floor with densely populated APUs 22 connected to the CPU 20 via several such “stripes” As a general matter, the CPU 20 can target a UE anywhere in the room by controlling one or several APUs 22 that are closest to the UE to transmit signals to and receive signals from the UE. In this example deployment, the APUs are spaced at 10 meters, in both x- and y-directions, which means that a UE is never more than about 7 meters away from one (or several) APUs, in the horizontal dimension.

It will be appreciated that the distribution of base station antennas into APUs as shown in FIGS. 1-3 can provide for shorter distances between the base station antennas and the antenna(s) for any given UE served by the base station, in many scenarios. This will be an enabler for the use of higher carrier frequencies, and thereby higher modulation/information bandwidths, both of which are key expectations for fifth-generation (5G) wireless networks.

Another requirement of 5G networks is that they support a high quality-of-service (QoS). To achieve this, it is necessary that the radio link between the mobile/device/machine (UE) and the base station be highly reliable and support low-latency communications. This is especially the case for industrial scenarios, for example, where mission-critical real-time communication is needed for communications with or between machines equipped with devices. These communications and the supporting technologies are referred to as ultra-reliable low-latency communications (URLLC).

### SUMMARY

In some 5G applications, URLLC is required. Using series-connected APUs and a single CPU, as shown in the example systems illustrated in FIGS. 2 and 3, makes the system vulnerable to single points of failure. If the CPU fails, the complete system is lost. If one APU fails, the link to all APUs farther away from the CPU on the same chain, or stripe, are also lost.

The present disclosure describes techniques and devices for providing improved robustness in a distributed wireless system that comprises at least one controlling node (or CPU) and two or more antenna processing nodes (or APUs) communicatively coupled to the at least one controlling node but spatially separated from each other and from the at least one controlling node. An example antenna processing node for use in such a system may comprise radio circuitry configured for radio communication with one or more wireless devices (e.g., UEs), as well as serial interface circuitry. The serial interface circuitry is (a) configured to communicate with a first controlling node in a first direction along a series of links serially connecting the first controlling node and two or more antenna processing nodes including the first antenna processing node, and (b) configured to relay communications between the first controlling node and at least a second antenna processing node, in a second direction along the series of links. The antenna processing node further comprises a processing circuit operatively coupled to the radio circuitry and to the serial interface circuitry, where the processing circuit is configured to, in response to determining that communications with the first controlling node in the first direction have failed, control the serial interface circuitry to communicate with a controlling node in the second direction along the series of links.

An example controlling node for use in such a distributed wireless system comprises serial interface circuitry configured to (a) communicate with a least a first one of the antenna processing nodes in a first direction along a series of links serially connecting the first controlling node and two or more antenna processing nodes, and (b) communicate with a least a second one of the antenna processing nodes in a second direction along the series of link. The controlling node further comprises a processing circuit operatively coupled to the serial interface circuitry, where the processing circuit is configured to, in response to determining that communications in the first direction with the first one of the antenna processing nodes have failed, control the serial interface circuitry to communicate with the first one of the antenna processing nodes in the second direction along the series of links.

Also described in detail below are methods carried out by antenna processing nodes and controlling nodes, according to various embodiments. One such method is carried out by a first antenna processing node in a distributed wireless system, and comprises communicating with a first controlling node in a first direction along a series of links serially connecting the first controlling node and two or more antenna processing nodes including the first antenna processing node, and relaying communications between the first controlling node and at least a second antenna processing node, in a second direction along the series of links. The method further comprises determining that communications with the first controlling node in the first direction have failed, and, in response, communicating with a controlling node in the second direction along the series of links.

Another example method is carried out by a first controlling node configured for use in a distributed wireless system that comprises the first controlling node and two or more antenna processing nodes communicatively coupled to the first controlling node but spatially separated from each other and from the first controlling node. According to this method, the first controlling node communicates with a least a first one of the antenna processing nodes in a first direction along a series of links serially connecting the first controlling node and two or more antenna processing nodes, and communicates with a least a second one of the antenna processing nodes in a second direction along the series of links. The method further comprises determining that communications in the first direction with the first one of the antenna processing nodes have failed, and, in response, communicating with the first one of the antenna processing nodes in the second direction along the series of links.

Details and variants of the methods and apparatuses summarized above are described in the detailed description below, and illustrated in the attached figures.

### BRIEF DESCRIPTION OF THE FIGURES

FIG. 1 is an illustration of an example cell-free massive MIMO system.

FIG. 2 illustrates an example deployment of a distributed wireless system.

FIG. 3 illustrates another example deployment of a distributed wireless system.

FIG. 4 is a block diagram of an example antenna processing node, according to some embodiments.

FIG. 5 illustrates an example deployment of a distributed wireless system modified according to some of the techniques described herein.

FIG. 6 illustrates another example deployment of a distributed wireless system modified according to some of the techniques described herein.

FIG. 7 illustrates still another example deployment of a distributed wireless system modified according to some of the techniques described herein.

FIG. 8 is a process flow diagram illustrating an example technique, according to some embodiments.

FIG. 9 is a process flow diagram of an example method carried out by an antenna processing node, according to some embodiments.

FIG. 10 is a process flow diagram illustrating an example method carried out by a controlling node, according to some embodiments.

FIG. 11 is a block diagram of an example controlling node, according to some embodiments.

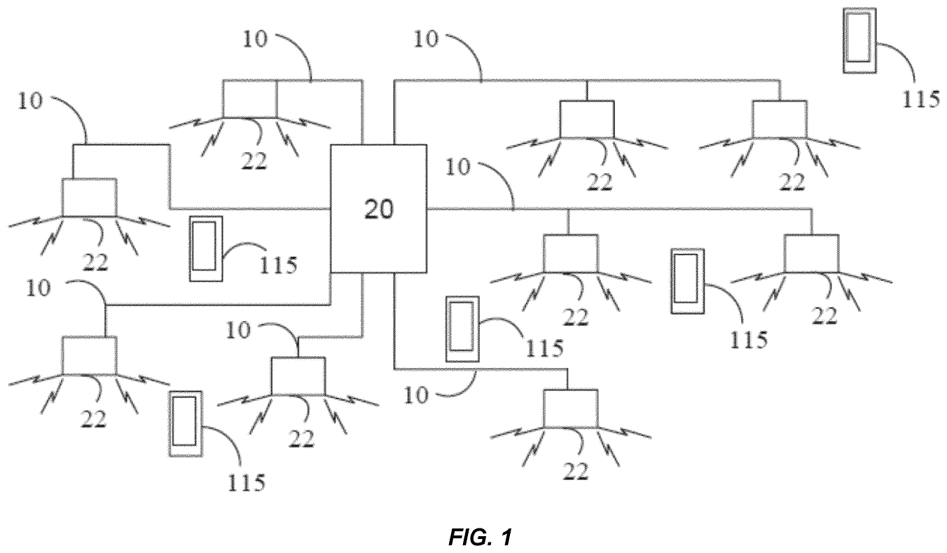

### DETAILED DESCRIPTION

There are several possible approaches for implementing the interconnections between the CPU in a distributed wireless system and the APUs that it controls. One approach is to implement the interconnections between the CPUs and the APUs as a high-speed digital interface, e.g., such as a high-speed Ethernet connection. With this approach, information to be transmitted by a given APUs is sent from the CPU to the APU as digital baseband information. This digital baseband information is then up-converted to a radiofrequency (RF) signal in the APU, for transmission over the air. In the other direction, RF signals received from a UE are down converted in the APU and converted to digital form before being sent over the digital link to the CPU, for further processing.

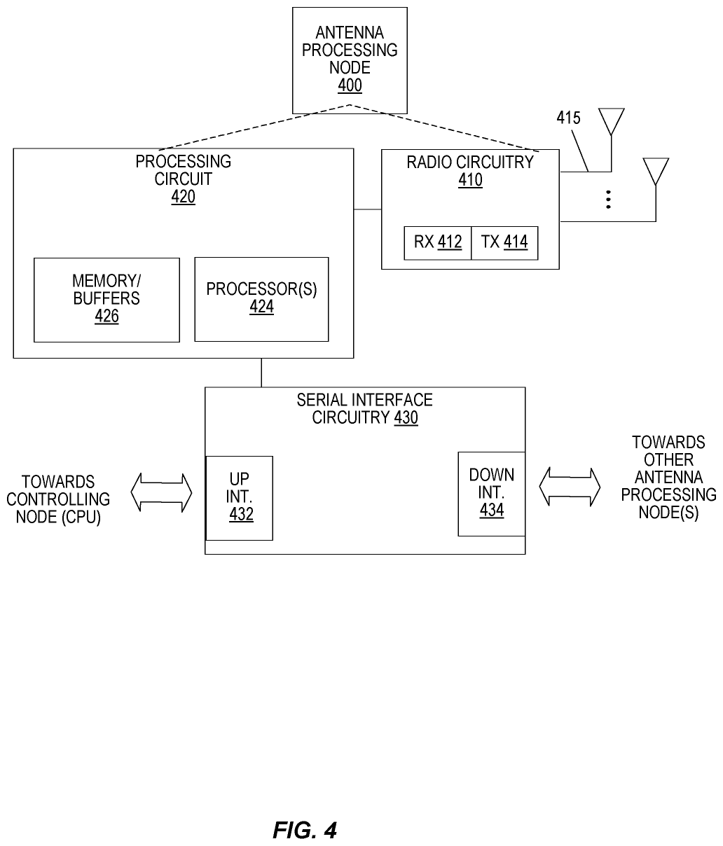

In such a system, communications along these serial links may be described as “upstream” and “downstream” communications, where upstream communications are communications in the direction towards the CPU while downstream communications are in the opposite direction, i.e., away from the CPU. In the upstream direction, each APU thus sends its own data towards the CPU, via an upstream serial interface, along with any data that it receives from one or more APUs that are further downstream, via a downstream serial interface. This is seen in FIG. 4, which is a block diagram illustrating components of an example APU, here illustrated as antenna processing node 400. As seen in the figure, the antenna processing unit 400 also receives communications for itself and for downstream APUs from the CPU, via the upstream serial interface 432, and forwards those communications intended for downstream APUs towards those APUs, via the downstream serial interface 434. Likewise, the antenna process unit 400 sends data that it receives from one or more UEs to the CPU via the upstream serial interface 432, while also receiving similar data from other APUs via the downstream serial interface 434, which it then forwards to the CPU via the upstream serial interface 432.

The required capacity of the fronthaul network formed by these serial links is proportional to the number of simultaneous data streams that the APUs in the series can spatially multiplex, at maximum network load. The required capacity of the backhaul of the CPU (i.e., the CPUs connection towards the core network) is the sum of the data streams that the serial links connecting the APUs to the CPUs will transmit and receive at maximum network node. The most straightforward way to limit these capacity requirements is to constrain the number the number of UEs that can be served per APU and CPU. Put another way, the capacity of the distributed wireless system to serve UEs may be limited by the maximum capacities of the serial links between the APUs to the CPUs.

The use of serial interfaces as described above is generally a good match for downlink (DL) communications, i.e., communications from a base station to one or more UEs. Note that the terms “wireless device,” “user equipment,” and “UEs” are used herein to refer to any wireless devices served by the distributed wireless systems described here, including wireless devices that do not have a “user” as such but that are connected to machines. The serial interfaces described here work well for downlink communications because the same information may be sent to all of the APUs involved in any given transmission to a wireless device. This downlink information may be the bits or data blocks that must be transmitted by the APUs, with each APU involved in the transmission separately performing its own coding, modulation, upconversion, and transmission. There are other possibilities, however, such as the CPU sending to the APUs a time-domain digital representation of a modulated in-phase/quadrature (I/Q) signal, for upconversion and transmission, or the CPU sending to the APUs a frequency-domain digital representation of I/Q symbols, for OFDMA modulation, upconversion, and transmission by the APUs. In any of these cases, when the CPU sends this downlink information to two or more APUs in the chain, it need only send one copy, with each APU forwarding the information further downstream, as necessary.

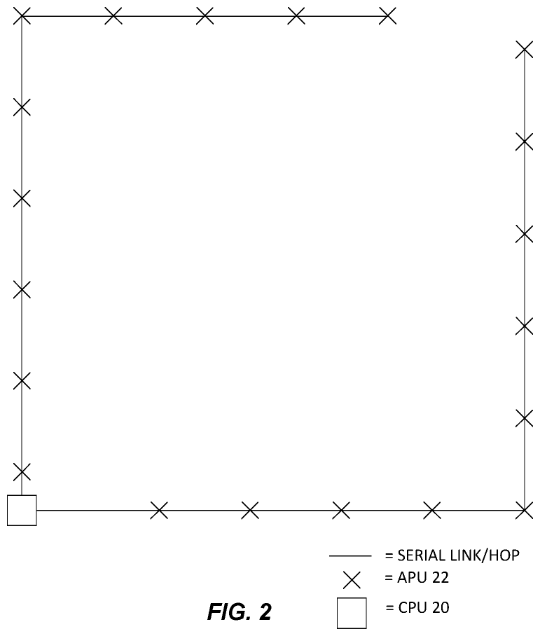

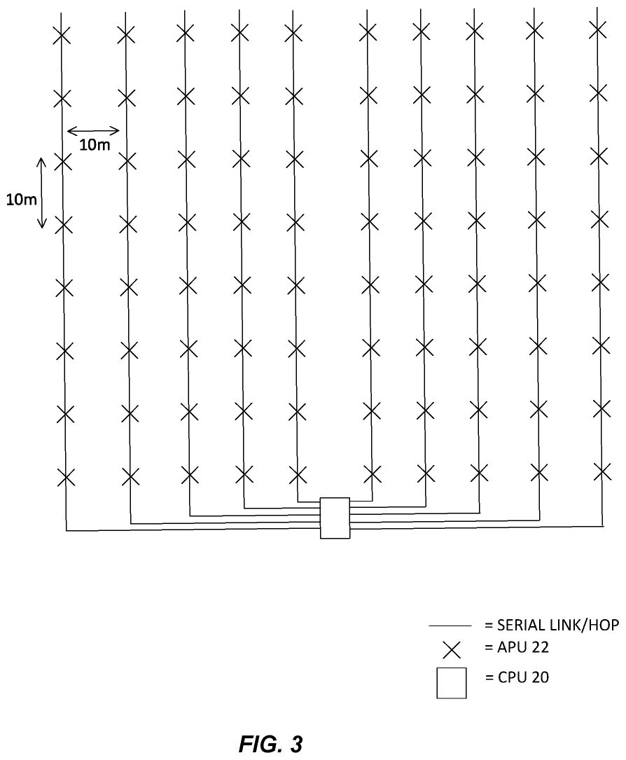

In some 5G applications, URLLC is required. Using series-connected APUs with a single CPU in a distributed wireless system like those shown in FIGS. 2 and 3 makes the system error-prone. If the CPU fails, the complete system is lost. If one APU fails, the link to all subsequent APUs is also lost. The series-connected interface means that all APUs need to be running their respective interfaces even when only one or a few APUs are actively transmitting/receiving. Assuming the interface is Ethernet and POE (power over ethernet) is used, inactive APUs will limit the power budget even when not involved in an active transmission. This will limit the maximum number of series connected APUs in a given deployment. Also, the maximum number of simultaneous active APUs will be reduced.

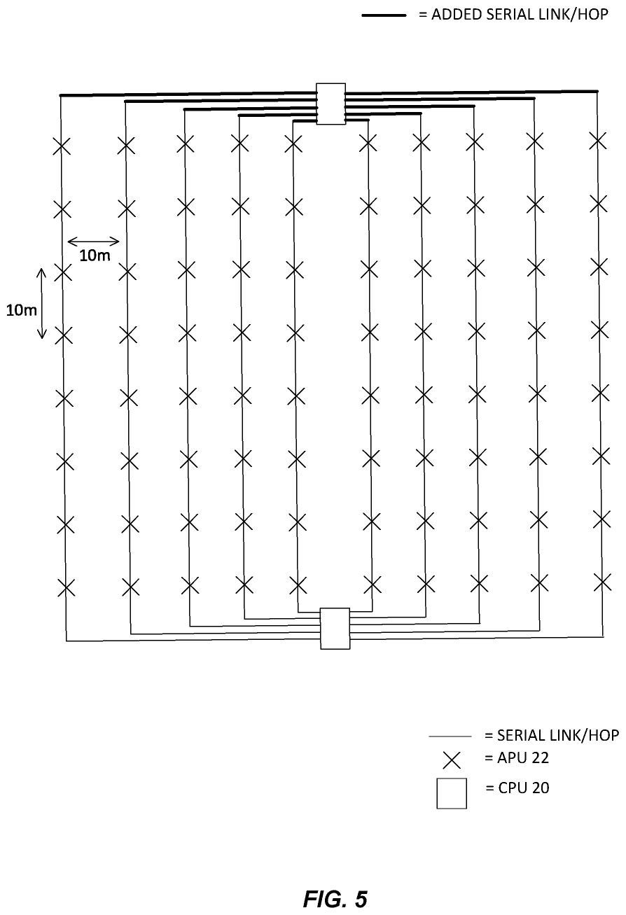

The embodiments disclosed herein may be used to improve the robustness of distributed wireless systems. One approach is to add another CPU at the other end of the stripes, as shown in FIG. 5. The example system illustrated in FIG. 5 has the same coverage area and the same number of APUs as the system shown in FIG. 3, but an additional CPU has been added, terminating each of the stripes at the opposite end from the first CPU. This will add redundancy, such that the system can still work even if one CPU and several APUs fail, improving system robustness.

In normal operation, the additional CPU may be left off, except for occasional monitoring of the health of the system, which may be achieved by having the operational CPU, which might be regarded as the “master” CPU, send status messages to the other, via the serial links. If the CPU in use fails, the additional CPU may be activated, in which case all of the APUs reverse the directions of their upstream and downstream serial communications.

Furthermore, if an APU fails or a connection to a particular APU fails, the additional CPU can be activated and communicate with those APUs that would otherwise have been isolated by the failure and thus inoperable. Those isolated APUs simply reverse the directions of their upstream and downstream serial communications. This might be triggered by the APU detecting that it is has stopped receiving communications from the CPU via the upstream serial interface, in some embodiments. In others, the APU might detect a command from the previously non-operational CPU, received via the downstream serial interface, this command instructing the APU to reverse its upstream and downstream serial communications.

In an alternative approach to operating a system with redundant CPUs, as shown in FIG. 5, is to have both CPUs active all the time, with each APU communicating with the closest CPU (e.g., in terms of number of intervening APUs). This halves the effective number of series-connected APUs in each stripe, with respect to the communications running along the stripe, and facilitates covering a larger area with the same APU density. If a failure occurs, the system still has redundancy, but the system's overall capacity may be reduced.

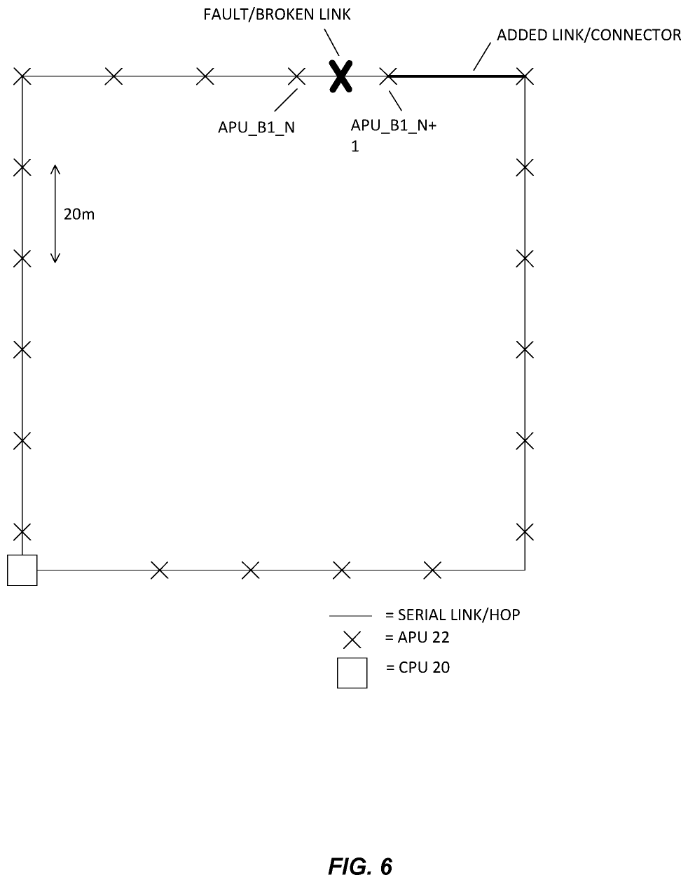

In a simplified approach, the APUs may be connected in loops, e.g., as shown in FIG. 6. Then if one APU fails, all of the remaining APUs are still connected to the same CPU, although some may have to communicate in a different direction than before the failure. FIG. 6 illustrates an embodiment where some redundancy is added in the square application by also connecting the APUs at the far end of the stripes or branches, remote from the CPU, i.e., by adding a link connecting branch 1 and branch2. In normal operation, this connection is not used. But if one APU fails, e.g., APU_B1_N+1, or a connection to this APU fails, the new connection is activated, and the CPU can still access all remaining APUs, or even this APU, if still functional. In operation, the CPU can regularly poll all APUs to see if they are still operational. If one APU is found to be malfunctional, the added connection is enabled, and those APUs on the wrong side of the failing one should communicate with the CPU in the opposite direction than was previously used. This will be discussed in further detail below.

The loop concept can of course also be implemented in the scenario shown in FIG. 3, with pairs of the stripes shown in FIG. 3 connected to each other to form closed loops with the CPU.

Note that modifying the system of FIG. 3 in this way does not provide redundancy with respect to the CPU itself, but only with respect to APU connectivity. The same is true for the example shown in FIG. 6. This is a tradeoff between reliability and system complexity.

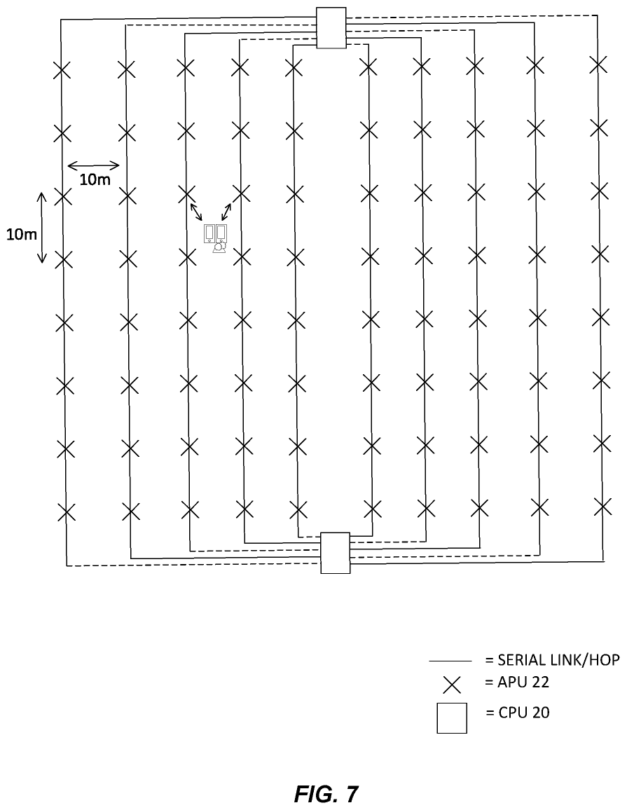

For URLLC to increase reliability on the UE side of the network, a given industrial device can be equipped with two or more independent user equipments (UEs), providing a degree of redundancy at the machine end of the wireless connection. These two or more independent UEs can transmit and receive the same information, increasing system reliability. This is illustrated in FIG. 7. In the example system shown in FIG. 7, each of the two CPUs has primary control over alternating stripes. For maximum redundancy, the system can be operated so that the two UEs serving a given machine are connected to different CPUs, via different APUs on different stripes.

More particularly, a controlling device, whether in the industrial machine or elsewhere, has or receives information about the relationship between the machine and the two (or more) independent UEs. The UEs or the APUs are controlled so that each UE is served by a different APU, with those different APUs being controlled by different CPUs. When scheduling data to be sent to or received from the industrial machine, the same data is scheduled for both UEs, APUs, and CPUs, to maximize redundancy.

Besides providing operational redundancy, connecting the two UEs to different APUs means that the UEs will observe different radio channels, as well, such that the system is enhanced by radio diversity as well. Each stripe can be terminated at both ends, with a different CPU, providing redundancy and robustness to device or connection failures in the same manner that was shown in FIG. 5. These redundant links are shown in FIG. 7 as dashed lines. In the event that one of the

CPUs fails, APUs served by that CPU can change directions with respect to their serial communications, so as to be served by the other CPU via these redundant links. While at this point the industrial machine's two UEs will be communicating through a single CPU, the system remains operational, albeit with reduced redundancy, until the failure can be corrected, via routine or emergency maintenance.

As noted above, to exploit the various types of redundancy created by connecting another APU to the distributed wireless system or by adding additional connections, e.g., to form a loop, as was illustrated in FIGS. 5, 6, and 7, each APU affected by a system failure needs to begin communicating with the CPU in the opposite direction, compared to previous communications. More generally, each APU needs to be keep track of the direction in which it should communicate with the CPU.

As suggested above, in some embodiments an APU might become aware that it needs to switch directions for its communications with the CPU based on a sudden absence of expected communications from the CPU in the direction that those communications were previously received. In other embodiments, the APU may be capable of detecting CPU commands received from either the downstream serial interface or the upstream serial interface. In these embodiments, the APU may be configured to switch directions for its communications based on receiving an explicit command to do so, or based on receiving a CPU command from the opposite direction, compared to previously received CPU commands.

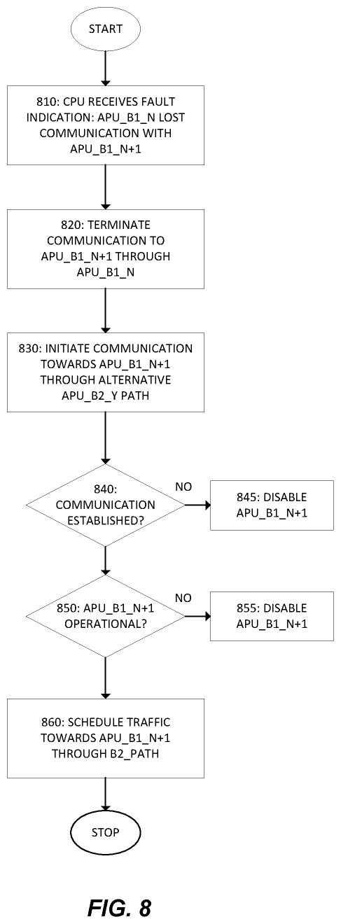

FIG. 8 illustrates a procedure, as carried out by a CPU connected to at least two stripes, or branches, where at least some of the APUs can be reached via either of the stripes through a redundant connection, e.g., as shown in FIG. 6. As shown at block 810, the CPU receives an indication of a fault concerning a particular APU. In this example, an APU identified as APU_B1_N has reported that it has lost communication with APU_B1_N+1, where APU_B1_N+1 is further downstream branch 1 than APU_B1_N, with respect to current directions for communications. This loss in communication could be the result of a failure of APU_B1_N+1 itself, or the result of a failure of the serial link connecting APU_B1_N and APU_B1_N+1.

As shown at block 820, the CPU responds by terminating communications to APU_B1_N+1 via APU_B1_N. Instead, as shown at block 830, the CPU initiates communications with APU_B1_N+1 via an alternate path, here indicated as branch 2 (B2). This means that the CPU will be communicating with APU_B1_N+1 from the other direction (with respect to APU_B1_N+1), as compared to before the fault.

As shown at blocks 840 and 845, if the CPU is unable to establish communications with APU_B1_N+1 at all, it marks APU_B1_N+1 as disabled, which means that it will no longer be relied upon for communicating with UEs in the covered area. Likewise, if the CPU is able to establish communications with APU_B1_N+1, but determines that APU_B1_N+1 is suffering a fault that makes it unusable, the CPU likewise marks APU_B1_N+1 as disabled, as shown at blocks 850 and 855.

Otherwise, if the CPU is able to establish communications with APU_B1_N+1 through branch 2, it controls APU_B1_N+1 and schedules traffic for UEs served by APU_B1_N+1 via branch 2, as shown at block 860. Note that any APUs that were previously downstream from APU_B1_N+1 (e.g., APU_B1_N+2) will also be controlled through branch 2 beginning at this time—these APUs will now be upstream of APU_B1_N+1. Further, it should be appreciated that even if APU_B1_N+1 is determined to be disabled, those APUs previously downstream from APU_B1_N+1 on branch 1 should still be reachable through branch 2.

In systems where there are two CPUs, e.g., as shown in FIGS. 5 and 7, the CPUs can be in contact, e.g., through one or several branches. In the event that one or both CPUs detects a failure somewhere in the system, the CPUs can negotiate with respect to which should take over control of one or more of the APUs. If one of the CPUs fails entirely, the other can take over and initiate communications with the APUs, thereby causing the APUs to reverse the directions of their upstream and downstream communications.

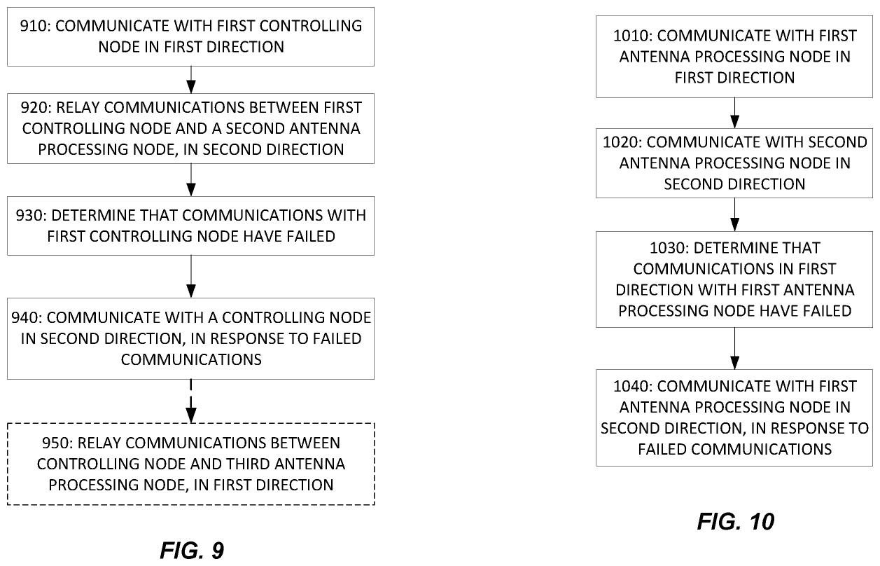

FIG. 9 illustrates an example method carried out by a first antenna processing node configured for use in a distributed wireless system that comprises at least one controlling node and two or more antenna processing nodes, including the first antenna process node, communicatively coupled to the at least one controlling node but spatially separated from each other and the at least one controlling node. Again, here the terms “controlling node” and “antenna processing nodes” are used interchangeably with the terms “CPU” and “APU,” respectively. Thus, the method of FIG. 9 is applicable to distributed wireless systems like those shown in FIGS. 5, 6, and 7, as well as others, and applies to a scenario where, for example, another antenna processing node has failed, or a link between antenna processing nodes and a controlling node has failed, or a controlling node has failed.

The method illustrated in FIG. 9 begins, as shown at block 910, with the first antenna processing node communicating with a first controlling node in a first direction along a series of links serially connecting the first controlling node and two or more antenna processing nodes, including the first antenna processing node. As shown at block 920, the first antenna processing node also relays communications between the first controlling node and at least a second antenna processing node, in a second direction along the series of links. Note that at this point, the first direction may be considered the upstream direction, while the second direction is the downstream direction, with respect to the first antenna processing node.

As shown at block 930, the first antenna processing node determines that communications with the first controlling node in the first direction have failed. The first antenna processing node might make this determination based on receiving an explicit command from a controlling node to change directions, in some embodiments, or by determining that communications from the first direction have stopped, in others. In either case, the first antenna processing node begins communicating with a controlling node in the second direction along the series of links, in response to this determining, as shown at block 940.

In some embodiments or instances, the controlling node that the first antenna processing node is now communicating with in the second direction may be the same controlling node it was previously communicating with (i.e., the first controlling node), e.g., in a situation where the APUs and the first controlling node are connected in a loop. In other embodiments or instances, e.g., in a system where redundant controlling nodes are employed, the first antenna processing node may be communicating with a second controlling node in the second direction, at this point.

It will be appreciated that the upstream and downstream directions for this first antenna processing node have now been changed, with the change in direction for communicating with a controlling node. In some instances, it may be the case that there are one or more other antenna processing nodes, in the new downstream direction, that need to be controlled through the first antenna processing node. In such a scenario, then, the method shown in FIG. 9 may further comprise relaying communications between the controlling node (whether the same controlling node as before or a new one) and at least a third antenna processing node, as shown at block 950. Because the second antenna processing node mentioned above is now upstream of the first antenna processing node, the first antenna processing node will no longer be responsible for relaying communications between the second antenna processing node and the controlling node. Rather, the situation will now be reversed—the second antenna processing node will relay communications between the first antenna processing node and the controlling node.

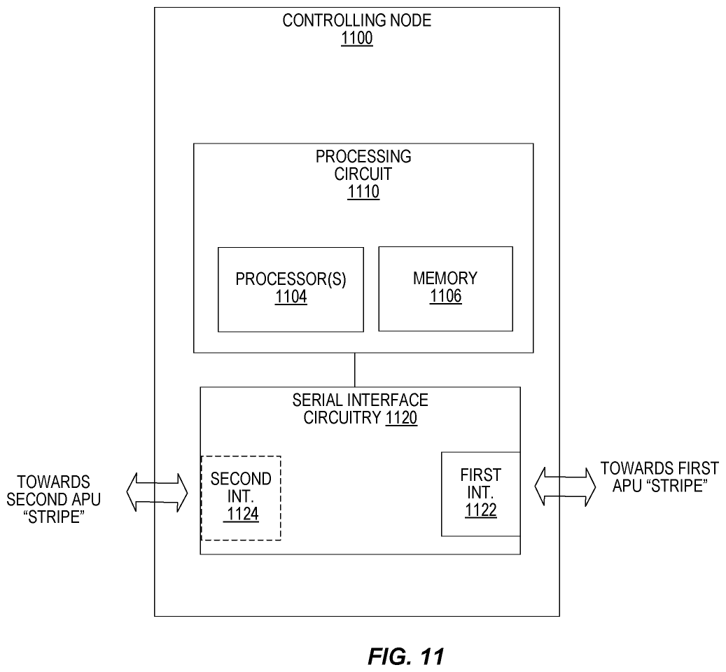

FIG. 10 is a process flow diagram illustrating an example method complementing the techniques illustrated in FIG. 9. The method shown in FIG. 10 focuses on operations carried out by a controlling node of a distributed wireless system that comprises the controlling node and two or more antenna processing nodes communicatively coupled to the controlling node but spatially separated from each other and from the controlling node. Once again, here the terms “controlling node” and “antenna processing nodes” are used interchangeably with the terms “CPU” and “APU,” respectively.

More particularly, the method shown in FIG. 10 applies to a scenario where the controlling node and two or more antenna processing nodes are connected in a loop. The illustrated method begins, as shown at block 1010, with communicating with a least a first one of the antenna processing nodes in a first direction along a series of links serially connecting the first controlling node and two or more antenna processing nodes. Similarly, the controlling node communicates with a least a second one of the antenna processing nodes in a second direction along the series of links, as shown at block 1020. These first and second directions thus correspond to two different branches, or stripes, connected to the controlling node. From the perspective of the controlling node, the antenna processing nodes on both of these branches are “downstream” antenna processing nodes; the distinction between upstream and downstream is relevant only with respect to an antenna processing node.

As shown at block 1030, the method continues with the controlling node determining that communications in the first direction with the first one of the antenna processing nodes have failed. In response, as shown at block 1040, the controlling node begins communicating with the first one of the antenna processing nodes in the second direction along the series of links, in response to said determining. Note that it may be the case that the first one of the antenna processing nodes was downstream of one or more other antenna processing nodes in the first direction—in this case the controlling node may still be able to communicate with those one or more other antenna processing nodes in the first direction. However, if the controlling node was previously communicating in the first direction with an antenna processing node further downstream than the first one of the antenna processing nodes in the first direction, the controlling node will need to begin communicating with that antenna processing node in the second direction as well. Antenna processing nodes previously reached via the second direction may be unaffected, except that they will now be relaying communications between the controlling node and the first one of the antenna processing nodes, in addition to their other responsibilities.

FIG. 11 is a block diagram illustrating an example controlling node 1100, according to some embodiments. Controlling node 1100 includes a processing circuit 1110, which in turn includes one or more processors 1104, controllers, or the like, coupled to memory 1106, which may comprise one or several types of memory, such as random-access memory, read-only memory, flash memory, etc. Stored in memory 1106 may be computer program code for execution by processor(s) 1104, including program code configured to cause the controlling node 1100 to carry out any one or more of the techniques described herein, such as the methods discussed above in connection with FIGS. 8 and 10.

Controlling node 1100 further comprises serial interface circuitry 1120 operatively coupled to the processing circuit 1110. Serial interface circuitry 1120 includes a first serial interface 1122 configured to transmit data to and receive data from one or several antenna processing nodes connected in series, via a serial link connected to the serial interface 1122. The one or several antenna processing nodes connected via this first serial interface 1122 may be considered to be a first stripe, branch, or chain. Serial interface circuitry 1120 also comprises a second serial interface 1124, configured to transmit data to and receive data from a second set of antenna processing nodes connected in series, via a serial link connected to the second serial interface 1124. These antenna processing nodes may be considered to be a second stripe, branch, or chain. Thus, the controlling node 1100 may be able to separately control two (or more) stripes, branches, or chains of antenna processing nodes, through respective serial interfaces.

More particularly, it will be appreciated that serial interface circuitry 1120 is (a) configured to communicate with a least a first one of the antenna processing nodes in a first direction along a series of links serially connecting the first controlling node and two or more antenna processing nodes, and (b) communicate with a least a second one of the antenna processing nodes in a second direction along the series of links. The processing circuit 1110 is operatively coupled to the serial interface circuitry 1120, and, in accordance with the techniques described above, may be configured to, in response to determining that communications in the first direction with the first one of the antenna processing nodes have failed, control the serial interface circuitry to communicate with the first one of the antenna processing nodes in the second direction along the series of links.

While not shown in FIG. 11, in some embodiments the controlling node 1100 may be collocated with or include an antenna processing node or comparable functionality, e.g., as shown in FIG. 4. From a functional standpoint, this collocated antenna processing node functionality may be treated in the same manner as other antenna processing nodes in a series.

Referring again to FIG. 4, this figure is a block diagram illustrating an example antenna processing node 400, according to some embodiments. Antenna processing node 400 includes radio circuitry 410 and antennas 415, processing circuit 420, and serial interface circuitry 430, which includes a first serial interface 432, initially facing “upstream” towards a controlling node, as well as a second serial interface 434, initially facing “downstream,” towards one or more subsequent antenna processing nodes.

Radio circuitry 410 includes receive (RX) and transmit (TX) functionality for communicating with one or more wireless devices via antennas 415. For downlink communications, i.e., radio communications to one or more wireless devices, the radio circuitry 410 includes TX circuitry 414 configured to receive baseband information relayed to the radio circuitry 410 from a controlling node, via the upstream serial interface 432 and the processing circuit 420. TX circuitry 414 includes upconverter circuits, power amplifier circuits, and filter circuits to convert this baseband information to radio frequency and condition it for transmission to one or more wireless devices. For uplink communications, i.e., radio communications from one or more wireless devices, the radio circuitry 410 includes RX circuitry 412 configured to receive wireless transmissions via antennas 415, amplify, filter, and downconvert the received transmissions, and sample the downconverted transmissions to obtain soft information corresponding to the received wireless transmission. This soft information may be in the form of I-Q samples, for instance, and may be interchangeably referred to as soft bits or soft bit information. The soft bit information is passed to processing circuit 420, for processing and further handling, which may include sending the soft bit information to the controlling node.

Processing circuit 420 includes one or more processors 424, controllers, or the like, coupled to memory 426, which may comprise one or several types of memory, such as random-access memory, read-only memory, flash memory, etc. Stored in memory 426 may be computer program code for execution by processor(s) 424, including program code configured to control the radio circuitry 410 and serial interface circuitry 430 and to cause the antenna processing node 400 to carry out any one or more of the techniques described herein, such as the methods discussed above in connection with FIG. 9.

Thus, for example, serial interface circuitry 430 may be initially (a) configured to communicate with a first controlling node in a first direction along a series of links serially connecting the first controlling node and two or more antenna processing nodes, including the first antenna processing node, and (b) configured to relay communications between the first controlling node and at least a second antenna processing node, in a second direction along the series of links. The processing circuit 420, which is operatively coupled to the radio circuitry 410 and to the serial interface circuitry 430, may be configured to, in response to determining that communications with the first controlling node in the first direction have failed, control the serial interface circuitry to communicate with a controlling node in the second direction along the series of links. As discussed above, this controlling node may be the same controlling node that the antenna processing node 400 was previously communicating with, except in the first direction, or it may be a different, redundant, controlling node. It will be appreciated that the several variants of the techniques described above, e.g., as discussed in connection with FIG. 9, are applicable to the antenna processing node 400 shown in FIG. 4.

Further embodiments comprise distributed wireless systems comprising one or more controlling nodes like those described above as well as one or more antenna processing nodes. These distributed wireless systems may be deployed in any of a wide variety of configurations, including configurations that resemble or that build upon the configurations shown in FIGS. 5, 6, and 7.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Hence, it should be understood that the details of the described embodiments are merely for illustrative purpose and by no means limiting. Instead, all variations that fall within the range of the claims are intended to be embraced therein.

1-16. (canceled)

17. A first antenna processing node for use in a distributed wireless system that comprises at least one controlling node and two or more antenna processing nodes, including the first antenna processing node, communicatively coupled to the controlling node but spatially separated from each other and from the controlling node, wherein the first antenna processing node comprises:
radio circuitry configured for radio communication with one or more wireless devices;
serial interface circuitry, wherein the serial interface circuitry is (a) configured to communicate with a first controlling node in a first direction along a series of links serially connecting the first controlling node and two or more antenna processing nodes including the first antenna processing node, and (b) configured to relay communications between the first controlling node and at least a second antenna processing node, in a second direction along the series of links; and
a processing circuit operatively coupled to the radio circuitry and to the serial interface circuitry, wherein the processing circuit is configured to, in response to determining that communications with the first controlling node in the first direction have failed, control the serial interface circuitry to communicate with a controlling node in the second direction along the series of links.

18. The first antenna processing node of claim 17, wherein the processing circuit is configured to control the serial interface circuitry to communicate with the first controlling node in the second direction, in response to determining that communications with the first controlling node in the first direction have failed.

19. The first antenna processing node of claim 18, wherein the processing circuit is further configured to, in response to determining that communications with the first controlling node in the first direction have failed, control the serial interface circuitry to relay communications between the first controlling node, in the second direction, and at least a third antenna processing node, in the first direction.

20. The first antenna processing node of claim 17, wherein the processing circuit is configured to control the serial interface circuitry to communicate with a second controlling node in the second direction, in response to determining that communications with the first controlling node in the first direction have failed.

21. The first antenna processing node of claim 20, wherein the processing circuit is further configured to, in response to determining that communications with the first controlling node in the first direction have failed, control the serial interface circuitry to relay communications between the second controlling node, in the second direction, and at least a third antenna processing node, in the first direction.

22. A first controlling node for use in a distributed wireless system that comprises the first controlling node and two or more antenna processing nodes communicatively coupled to the first controlling node but spatially separated from each other and from the first controlling node, wherein the first controlling node comprises:
serial interface circuitry, wherein the serial interface circuitry is configured to (a) communicate with a least a first one of the antenna processing nodes in a first direction along a series of links serially connecting the first controlling node and two or more antenna processing nodes, and (b) communicate with a least a second one of the antenna processing nodes in a second direction along the series of links; and
a processing circuit operatively coupled to the serial interface circuitry, wherein the processing circuit is configured to, in response to determining that communications in the first direction with the first one of the antenna processing nodes have failed, control the serial interface circuitry to communicate with the first one of the antenna processing nodes in the second direction along the series of links.

23. A distributed wireless system, comprising:
a first controlling node; and
two or more antenna processing nodes communicatively coupled to the first controlling node but spatially separated from each other and from the first controlling node, each of the two or more antenna processing nodes comprising radio circuitry configured for radio communication with one or more wireless devices;
wherein at least a first one of the antenna processing nodes further comprises:
serial interface circuitry configured to (a) communicate with the first controlling node in a first direction along a series of links serially connecting the first controlling node and the two or more antenna processing nodes, including the first antenna processing node, and (b) relay communications between the first controlling node and at least a second antenna processing node, in a second direction along the series of links; and
processing circuit operatively coupled to the radio circuitry and to the serial interface circuitry, wherein the processing circuit is configured to, in response to determining that communications with the first controlling node in the first direction have failed, control the serial interface circuitry to communicate with a controlling node in the second direction along the series of links.

24. The distributed wireless system of claim 23, wherein the first controlling node and the two or more antenna processing nodes are serially connected in a loop, such that the processing circuit of the first one of the antenna processing nodes controls the serial interface circuitry to communicate with the first controlling node in the second direction, in response to determining that communications with the first controlling node in the first direction have failed.

25. The distributed wireless system of claim 23, further comprising a second controlling node serially connected to the two or more antenna processing nodes in the second direction along the series of links, such that the processing circuit of the first one of the antenna processing nodes controls the serial interface circuitry to communicate with the second controlling node in the second direction, in response to determining that communications with the first controlling node in the first direction have failed.

26. The distributed wireless system of claim 25, wherein the second controlling node comprises processing circuitry configured to detect that the first controlling node has failed and, in response to detecting that the first controlling node has failed, send a message to the first one of the antenna processing nodes instructing the first one of the antenna processing nodes to communicate with the second controlling node, in the second direction, and wherein the processing circuit of the first one of the antenna processing nodes is configured to determine that communications with the first controlling node in the first direction have failed by receiving the message from the second controlling node.

27. A method, in a first antenna processing node configured for use in a distributed wireless system that comprises at least one controlling node and two or more antenna processing nodes, including the first antenna processing node, communicatively coupled to the at least one controlling node but spatially separated from each other and from the at least one controlling node, the method comprising:
communicating with a first controlling node in a first direction along a series of links serially connecting the first controlling node and two or more antenna processing nodes including the first antenna processing node;
relaying communications between the first controlling node and at least a second antenna processing node, in a second direction along the series of links;
determining that communications with the first controlling node in the first direction have failed; and
communicating with a controlling node in the second direction along the series of links, in response to said determining.

28. The method of claim 27, wherein said communicating with a controlling node in the second direction comprises communicating with the first controlling node in the second direction.

29. The method of claim 28, wherein the method further comprises, in response to determining that communications with the first controlling node in the first direction have failed, relaying communications between the first controlling node, in the second direction, and at least a third antenna processing node, in the first direction.

30. The method of claim 27, wherein said communicating with a controlling node in the second direction comprises communicating with a second controlling node, different from the first controlling node, in the second direction.

31. The method of claim 30, wherein the method further comprises, in response to determining that communications with the first controlling node in the first direction have failed, relaying communications between the second controlling node, in the second direction, and at least a third antenna processing node, in the first direction.
